(19) United States
(12) Patent Application Publication
(10) Pub. No.: US 2023/0259392 A1
(43) Pub. Date: Aug. 17, 2023

(54) DEPLOYMENT OF A PLURALITY OF SERVICES

(71) Applicant: International Business Machines Corporation, Armonk, NY (US)

(72) Inventors: Song Bai, Beijing (CN); Xiang Cai, Beijing (CN); Xiao Jian Lian, Beijing (CN); Yan Fen Guo, Beijing (CN); Chao Feng Wu, Beijing (CN); Hui Huang, Beijing (CN)

(21) Appl. No.: 17/671,687

(22) Filed: Feb. 15, 2022

(51) Int. Cl. G06F 9/48; G06F 9/455; G06F 9/38

(52) U.S. Cl. CPC G06F 9/4881; G06F 9/4856; G06F 9/45558; G06F 9/3838; G06F 2009/45595; G06F 2009/45583

(57) ABSTRACT

Embodiments of the present disclosure relate to deployment of a plurality of services. In an embodiment, a computer-implemented method is disclosed. According to the method, one or more processors receive a deployment event for a plurality of services in a computing cluster. One or more processors perform a reconciliation process in a virtualized operator environment for deployment of the plurality of services. The reconciliation process comprises obtaining, by the one or more processors, a plurality of task lists for the deployment of the plurality of services by parsing a service specification associated with the deployment event, and deploying, by the one or more processors, the plurality of services into the computing cluster by launching a plurality of executors to execute tasks in the plurality of task lists at least partially in parallel. In other embodiments, a system and a computer program product are disclosed.

### BACKGROUND

The present disclosure relates to computer techniques, and more specifically, to deployment of a plurality of services by a virtualized operator environment.

Today, there is an ever-increasing number of cloud-based products that are deployed in a pool of custom resources. Those products may consist of a group of services (or applications) such as database services, network connectivity services, firewall and security services, policy services (e.g., Policy Gateway servers), and so forth.

The custom resources may be virtualized and managed automatically as a computing cluster. An operator is a controller that can control, streamline, and automate the deployment of groups of services in a computing cluster. The operator may be configured to automate human operation knowledge and best practices to keep services running and healthy in the computing cluster.

### SUMMARY

According to one embodiment of the present disclosure, a computer-implemented method is provided. According to the method, one or more processors receive a deployment event for a plurality of services in a computing cluster. One or more processors perform a reconciliation process in a virtualized operator environment for deployment of the plurality of services. The reconciliation process comprises obtaining, by one or more processors, a plurality of task lists for the deployment of the plurality of services by parsing a service specification associated with the deployment event, and deploying, by one or more processors, the plurality of services into the computing cluster by launching a plurality of executors to—at least partially in parallel—execute tasks in the plurality of task lists.

According to this solution, by explicitly specifying the respective task lists for deployment of the plurality of services and launching a plurality of executors to execute the task lists to deploy the services, it enables the plurality of services to be deployed at least partially in parallel and thus decreases the deployment time consumption.

In some embodiments, the deployment event comprises an instance of a custom resource definition for the computing cluster. As used herein, a custom resource definition may include a defined amount of resources thought to be needed for a specified computing cluster. In some embodiments, parsing the service specification comprises parsing the service specification according to the instance of the custom resource definition. According to those embodiments, the service specification may be specifically defined according to a custom resource definition required for a certain computing cluster. In some instances, a custom resource is an object that allows you to introduce your own API into a project or a cluster. A custom resource definition (CRD) file defines your own object kinds and lets the API Server handle the entire lifecycle.

In some embodiments, parsing the service specification comprises: in response to the deployment event, launching a reconciler in the virtualized operator environment to parse the service specification. In some embodiments, launching the plurality of executors comprises triggering, by the reconciler, a master executor to be launched in the virtualized operator environment; distributing, by the reconciler, the plurality of task lists to the master executor; and in response to distributing the plurality of task lists, causing, by the master executor, the plurality of executors to be launched in the virtualized operator environment. According to those embodiments, corresponding components, e.g., the reconciler, may be preconfigured and then launched in the virtualized operator environment to perform the reconciliation process.

In some embodiments, the service specification indicates a dependency relationship between the plurality of services. In some embodiments, launching the plurality of executors comprises determining, based on the dependency relationship, an execution plan for at least partially parallel execution of the tasks in the plurality of task lists; and launching the plurality of executors according to the execution plan.

In some embodiments, the dependency relationship indicates that a first service of the plurality of services depends on a second service of the plurality of services, and a third service of the plurality of services does not depend on a fourth service of the plurality of services. In some embodiments, the execution plan indicates that tasks in a first task list of the plurality of task lists for deployment of the first service are to be executed after tasks in a second task list of the plurality of task lists for deployment of the second service, and tasks in a third task list of the plurality of task lists for deployment of the third service are to be executed in parallel with execution of tasks in a fourth task list of the plurality of task lists for deployment of the fourth service.

According to those embodiments, by considering the dependency relationship, in the case of multiple executors are to be launched, the dependency relationship between the services may be utilized to determine a more appropriate execution plan which may not only allow successful service deployment but also increase the deployment efficiency by allowing services without dependency to be deployed in parallel.

In some embodiments, the virtualized operator environment comprises an Ansible operator. In some embodiments, the service specification comprises a role list with each of the plurality of task lists specified as one role in the role list. The service deployment approach proposed in the present disclosure may be well adopted in the Ansible operator, to support service deployment in a more efficient way (e.g., where something is more efficient when it saves time and/or reduces the utilization of computing resources such as memory and/or processing power).

In some embodiments, the method further comprises collecting, by one or more processors, a plurality of execution results of the tasks in the plurality of task lists from the plurality of executors; and determining, by one or more processors, an event status for the deployment event based on the plurality of execution results, the event status indicating whether the deployment of the plurality of services successes or fails. The execution of the task lists by the multiple executors in accordance with the embodiments of the present disclosure may allow a fine-grained indication of execution results in deploying the respective services.

According to a further embodiment of the present disclosure, there is provided a system. The system comprises a processing unit and a memory coupled to the processing unit and storing instructions thereon. The instructions, when executed by the processing unit, perform acts of the method according to the embodiment of the present disclosure.

According to a yet further embodiment of the present disclosure, there is provided a computer program product being tangibly stored on a non-transient machine-readable medium and comprising machine-executable instructions. The instructions, when executed on a device, cause the device to perform acts of the method according to the embodiment of the present disclosure.

### BRIEF DESCRIPTION OF THE SEVERAL VIEWS OF THE DRAWINGS

Through the more detailed description of some embodiments of the present disclosure in the accompanying drawings, the above and other objects, features, and advantages of the present disclosure will become more apparent, wherein the same reference generally refers to the same components in the embodiments of the present disclosure.

FIG. 1 depicts a cloud computing node in accordance with some embodiments of the present disclosure.

FIG. 2 depicts a cloud computing environment in accordance with some embodiments of the present disclosure.

FIG. 3 depicts abstraction model layers in accordance with some embodiments of the present disclosure.

FIG. 4 depicts a block diagram of a service deployment platform in which embodiments of the present disclosure can be implemented.

FIG. 5 illustrates an example structure in a service specification.

FIG. 6 illustrates a traditional service deployment example in a virtualized operator environment.

FIG. 7A depicts a block diagram of an example data structure of a service specification in accordance with some embodiments of the present disclosure.

FIG. 7B depicts a block diagram of an example service specification in accordance with some embodiments of the present disclosure.

FIG. 8 depicts a flowchart of an example method in accordance with some embodiments of the present disclosure.

FIG. 9 depicts a block diagram of an example service deployment platform in accordance with some embodiments of the present disclosure.

FIG. 10 depicts a flowchart of an example service deployment process in accordance with some embodiments of the present disclosure.

FIG. 11 depicts an example portion of the virtualized operator environment considering the dependency relationship defined in the service specification in accordance with some other embodiments of the present disclosure.

FIG. 12 depicts an example dependency graph showing a dependency relationship from which an execution plan is determined in accordance with some embodiments of the present disclosure.

FIG. 13 depicts an example comparison of a total deployment time required using a traditional approach and a total deployment time in the example of FIG. 12 in accordance with some embodiments of the present disclosure.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

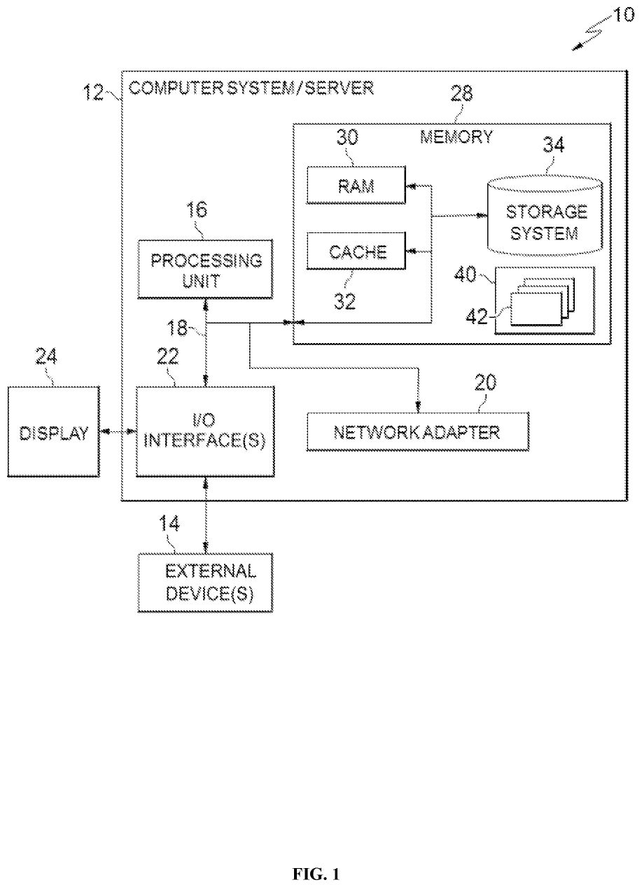

Referring now to FIG. 1, a schematic of an example of a cloud computing node is shown. Cloud computing node 10 is only one example of a suitable cloud computing node and is not intended to suggest any limitation as to the scope of use or functionality of embodiments of the disclosure described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

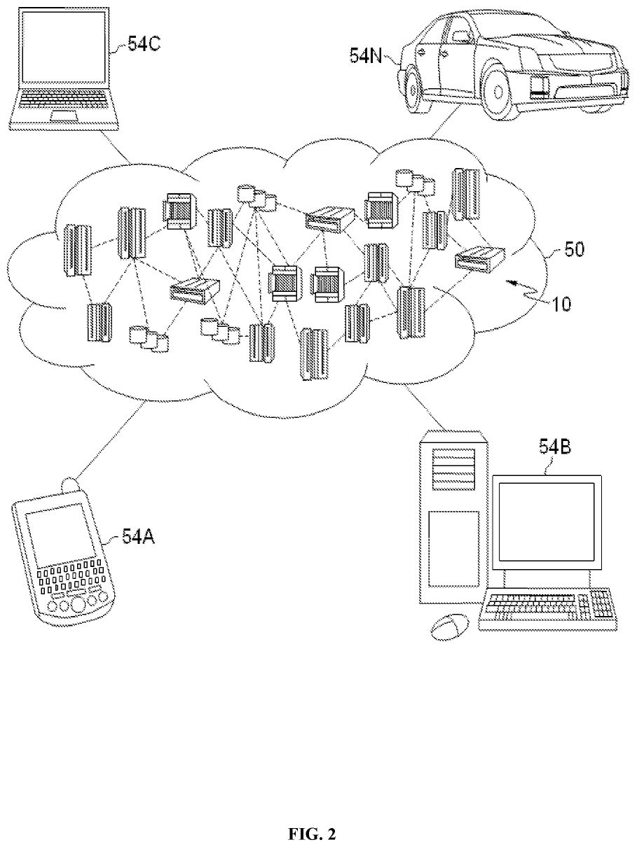

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

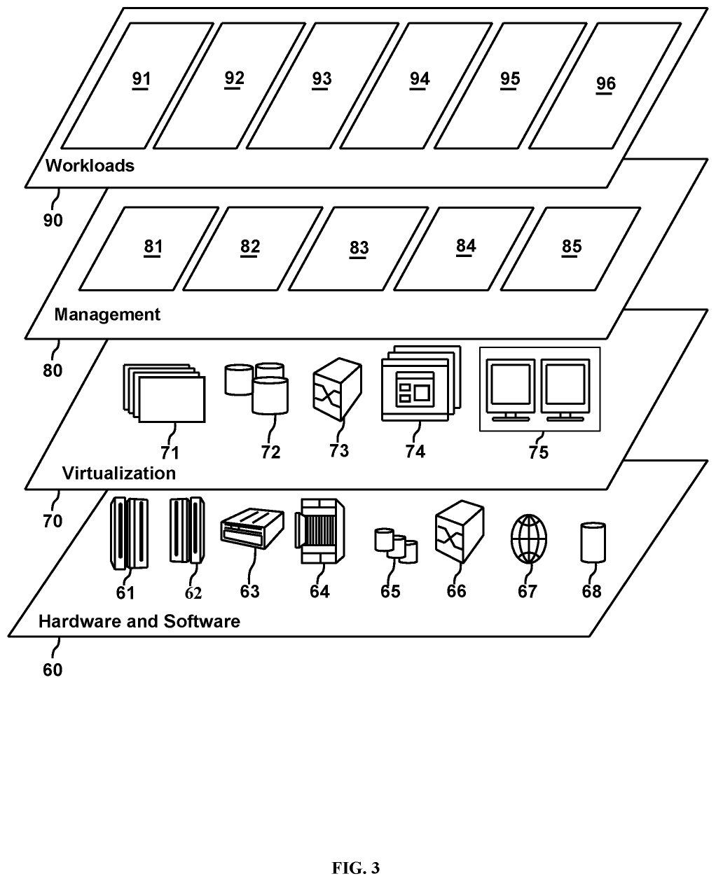

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and service deployment 96. The functionalities of service deployment 96 will be described in the following embodiment of the present disclosure.

As mentioned above, an operator can be utilized to control, streamline and automate the deployment of groups of services in a computing cluster. Such an operator can be deployed in a virtualized computing architecture, such as in a cloud, as a virtualized operator environment to implement the deployment.

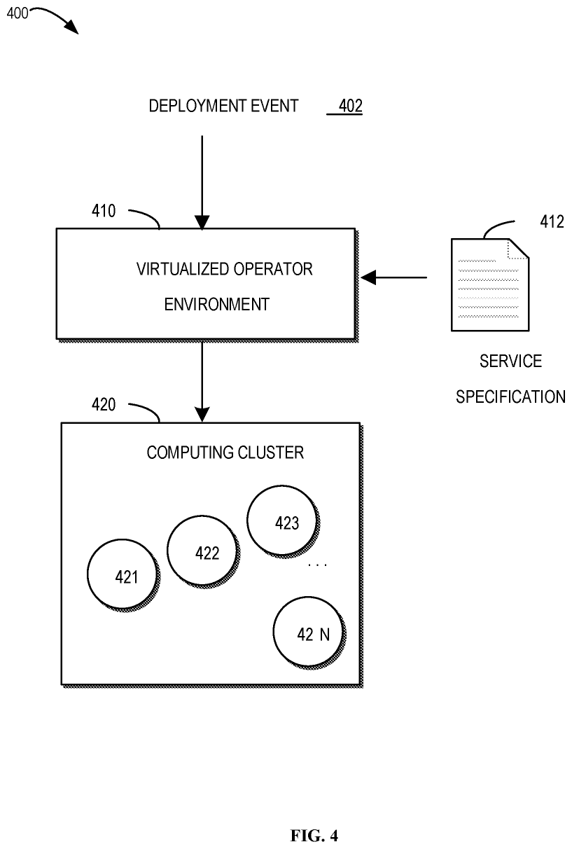

FIG. 4 depicts a block diagram of a service deployment platform 400 in which embodiments of the present disclosure can be implemented. As illustrated in FIG. 4, a virtualized operator environment 410 is deployed to control and manage deployment of services in one or more computing clusters, e.g., a computing cluster 420. The computing cluster 420 may consist of a group of configurable physical and/or virtual resources that can be utilized for running services. The resources may include, for example, servers, memories, storage, network connectivity, and so on.

In some embodiments, the overall platform 400 in FIG. 4 may be a cloud, such as a cloud based on the Kubernetes container platform. In some embodiments, related to a container-based cloud, the virtualized operator environment 410 may be an operator container which is launched as an instance of an operator within the cloud.

The virtualized operator environment 410 receives a deployment event 402 for a service or a group of services that are included in a software product. The virtualized operator environment 410 is operable to deploy the services into the computing cluster 420 according to a service specification 412. In some cases, the deployment event 402 includes a request for deployment of a new group of services or an application for a change to a group of services that has been deployed in the computing cluster 420. As illustrated, services 421, 422, 423, . . . , 42N may be deployed in the computing cluster 420.

The service specification 412 may include a custom resource definition (CRD) for a group of services associated with the software product, indicating a mapping between resources in the computing cluster 420 and the services. The service specification 412 may be of any data structure specifying tasks that are required to execute during the deployment of the services in the computing cluster 420. In some embodiments, the service specification 412 may comprise a plurality of segments each specifying tasks that are to be executed to deploy one or more groups of services. The deployment event 402 may indicate the group of services to be deployed so the virtualized operator environment 410 is able to perform the corresponding deployment.

The service specification 412 may be utilized to deploy a same group of services for a plurality of instances in the computing cluster 420. Each time when one or more of the deployed services are to be changed or a new group of services are to be deployed, the virtualized operator environment 410 may receive a deployment event 402. The deployment event 402 may be considered a custom resource instance for the CRD in the service specification 412.

In some embodiments, the service specification 412 may be a file written using a human-readable data serialization language such as YAML Ain′t Markup Language, YAML. The service specification 412 may be written in other languages.

One example of operators configured for automatic service deployment may include an Ansible Operator. An Ansible Operator is an operator that allows users to package operational knowledge (how to install and maintain the services) in the form of Ansible Roles and Playbooks. The Ansible Operator uses Ansible for the reconciliation logic. This logic (contained in roles or playbooks) is mapped to a particular computing cluster by a service specification (sometimes referred to as a watches.yaml file). The operator checks the service specification to determine which playbook or roles to execute, and then launches the playbooks/roles using Ansible Runners to execute corresponding tasks. The users can write the roles and playbooks so as to manage the services deployed in the computing cluster 420.

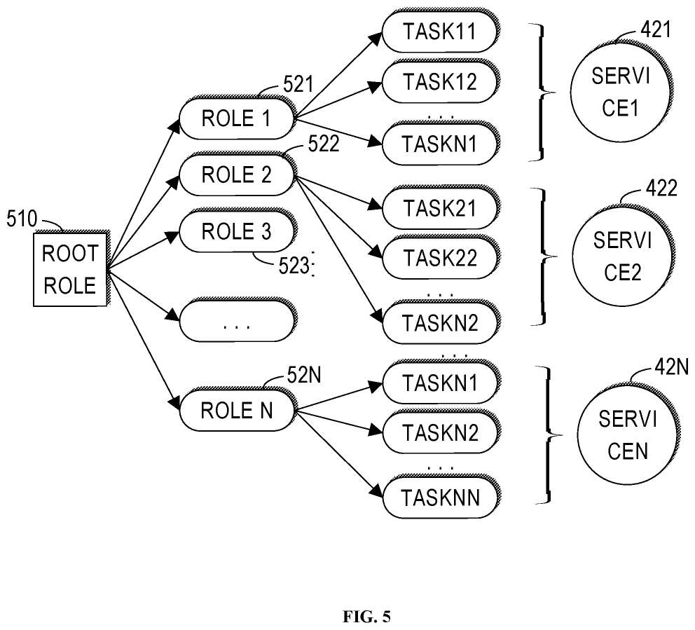

FIG. 5 illustrates an example structure for roles in a service specification 412. As illustrated, it is assumed that the services 421, 422, 423, . . . , 42N are comprised into a same software product. The service specification 412 may indicate a root role 510 which refers to a plurality of roles 521, 522, 523, . . . , 52N. Each of those roles specifies a task list, including a plurality of tasks that are to be executed when deploying a service. For example, the role 521 (also represented as Role1) specifies Task11, Task12, . . . , TaskN1 to be executed to deploy the service 421 (also represented as Service1), the role 522 (also represented as Role2) specifies Task21, Task22, . . . , TaskN2 to be executed to deploy the service 422 (also represented as Service2), the role 52N (also represented as RoleN) specifies TaskN1, TaskN2, . . . , TaskNN to be executed to deploy the service 42N (also represented as ServiceN), and so on.

In practice, some enterprise-level operators need to deploy a plurality of services via one virtualized operator environment. Traditionally, the virtualized operator environment may trigger a reconciliation process, to leverage one root role to invoke task lists specified by a plurality of roles in the service specification 412 orderly. The task list specified by one role may deploy one service. Thus, it leads to a long-elapsed time for one reconciliation process.

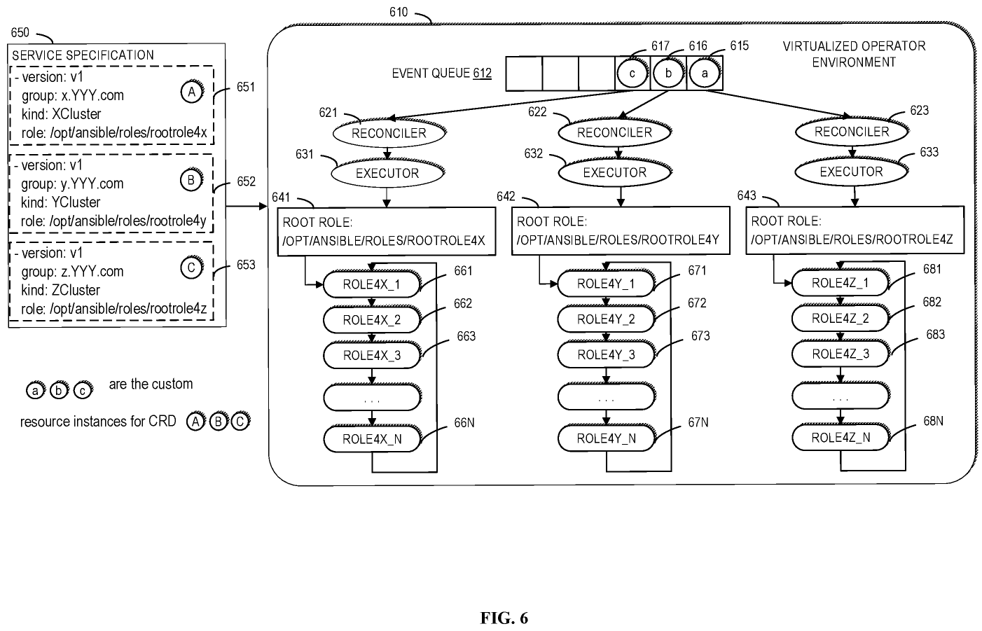

FIG. 6 illustrates a traditional service deployment example in a virtualized operator environment 610. In this example, the virtualized operator environment 610 is implemented as an Ansible Operator container. The virtualized operator environment 610 comprises an event queue 612 to store deployment events (represented as a 615, b 616, c 617), which are considered as custom resource instances for custom resource definitions 651, 652, and 653, respectively, in the service specification. A reconciler 621 may be launched in the virtualized operator environment 610. The reconciler 621 may fetch a deployment event from the event queue 612 and initiate a reconciliation process for service deployment.

Upon fetching of a deployment event a 615 for a plurality of services included in a software product, the reconciler 621 identifies, from a service specification 650, a custom resource definition 651 for the plurality of services. The custom resource definition 651 in the service specification 650 comprises version, group, kind, and role fields, to specify the version of a computing cluster into which the services are to be deployed (e.g., “v1”), the group of the computing cluster (e.g., “x.YYY.com”), the kind of the computing cluster, and a root role to be executed (e.g., “/opt/ansible/roles/rootrole4x”).

The reconciler 621 triggers an executor 631 (also referred to as a “runner”). The executor 631 may invoke a root role 641 specified in the custom resource definition A 651, to run a plurality of roles under the root role 641 sequentially. As illustrated in FIG. 6, the roles 661, 662, 663, . . . , 66N, (represented as Role4X_1, Role4X_2, Role4X_3, . . . , Role4X_N) are executed one by one sequentially. The running of a role is to execute a task in the task list specified by the role. As such, the plurality of services is deployed in a sequential order, which makes the deployment process time-consuming. It is impossible to make a new deployment or a deployment with a change to take effect in time. As a result, the customer experience is bad from the time and resource consuming view.

For some operators, such as the Ansible operator, it is possible to launch a plurality of reconcilers for service deployment of different software products. For example, as illustrated in FIG. 6, similarly to the deployment event a 615, a reconciler 622 is launched to fetch a deployment event b 616, and a reconciler 623 is launched to fetch a deployment event c 617 from the event queue 612. The reconcilers 622 and 623 may each identify a custom resource definition B 652 and a custom resource definition C 653 from the service specification 650 to deploy two other groups of services.

The reconciler 622 may trigger an executor 632 which invokes a root role 642 to run a plurality of roles under the root role 642 sequentially, including the roles 671, 672, 673, . . . , 67N, (represented as Role4Y_1, Role4Y_2, Role4Y_3, . . . , Role4Y_N). The reconciler 623 may trigger an executor 633 which invokes a root role 643 to run a plurality of roles under the root role 643 sequentially, including the roles 681, 682, 683, . . . 68N, (represented as Role4Z_1, Role4Z_2, Role4Z_3, . . . , Role4Z_N).

Executor 633 is supported in a virtualized operator environment to operate a plurality of reconcilers concurrently to perform respective reconciliation processes (as illustrated in FIG. 6) as long as the number of launched reconcilers does not exceed a maximum number. However, in some instances, executor 633 is not allowed to launch two or more reconcilers to operate for a same deployment event (and thus, for a same CRD and for a same software product). For an executor triggered by a reconciler, tasks in the task lists for services may be executed sequentially to deploy the services, which is time-consuming and have a long occupation time for computing resource in the virtualized operator environment.

In accordance with embodiments of the present disclosure, there is provided a solution for improved service deployment by a virtualized operator environment. In this solution, a service specification for a plurality of services is configured to specifically indicate a plurality of task lists for the deployment of the plurality of services. For example, instead of indicating a root role referring to a plurality of roles specifying the plurality of task lists, in some embodiments of the present disclosure, the service specification may indicate a role list with each role specifying a task list for deployment of one of the plurality of services. To deploy the plurality of services, a reconciliation process is performed in a virtualized operator environment by parsing the service specification to obtain the plurality of task lists and launching a plurality of executors to execute the plurality of tasks in the task lists, so as to deploy the plurality of services into the computing cluster.

According to this solution, by explicitly specifying the respective task lists for deployment of the plurality of services and launching a plurality of executors to at least partially parallelly execute tasks in the task lists to deploy the services, it enables the plurality of services to be deployed at least partially in parallel and thus decreases the deployment time consumption.

Some example embodiments of the present disclosure will be described in detail with reference to the accompanying drawings.

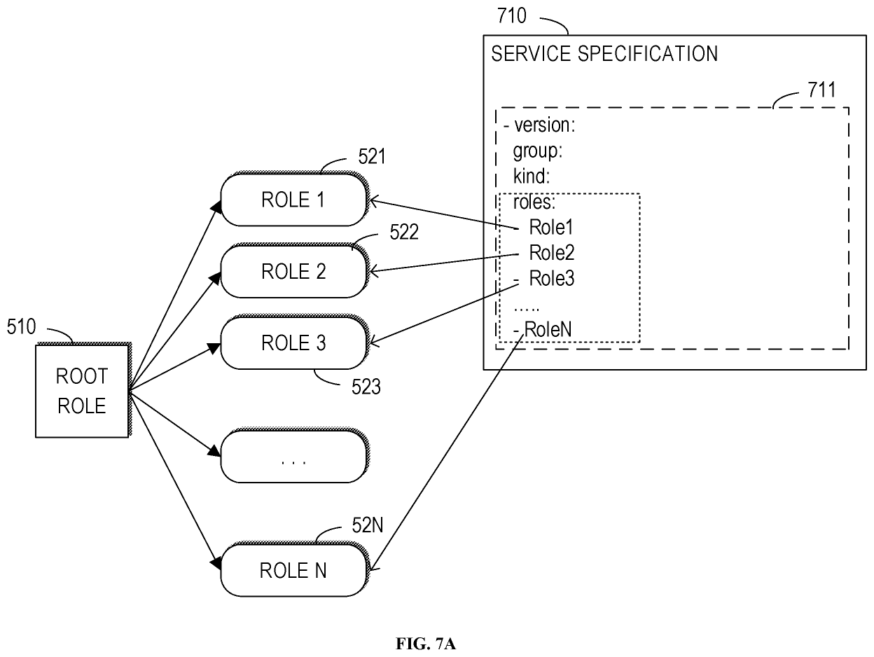

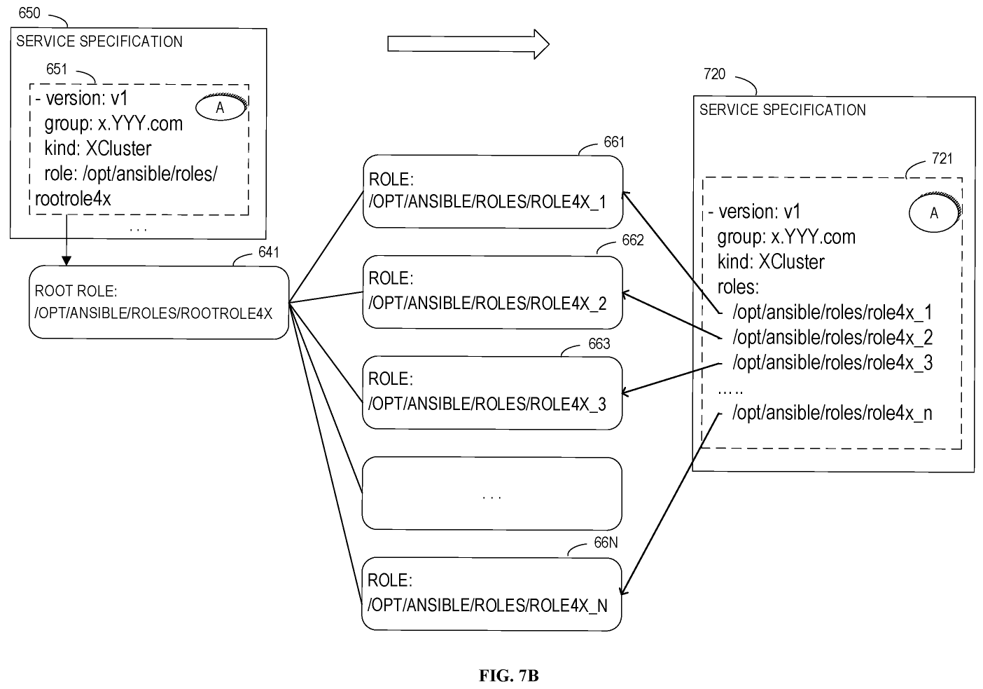

As mentioned above, in the present disclosure, a service specification for the plurality of services is configured to specifically indicate a plurality of task lists for the deployment of the plurality of services. FIG. 7A depicts a block diagram of an example data structure of a service specification 710 in accordance with some embodiments of the present disclosure. The service specification 710 may include a section of custom resource definition 711 for deployment of a plurality of services comprised in a software product. In this example, the data structure of the service specification 710 may be configured for an Ansible Operator as a file named watches.yaml. The service specification 710 may comprise the version, group, kind, and role fields to specify the version of a computing cluster into which the services are to be deployed, the group of the computing cluster, the kind of the computing cluster, and a root role to be executed.

The service specification 710 may further comprise a roles field to specify respective task lists, each task in the task list is to be executed to deploy one of the plurality of services. In some embodiments, each role may specify a recall path to recall the corresponding task list to run tasks in the corresponding task list to deploy the corresponding service. As illustrated, the roles field may include a list of roles, including Role1, Role2, Role3, . . . , RoleN. Those roles may refer to the plurality of roles 521, 522, 523, . . . , 52N as illustrated in FIG. 5 which share a same root role 510.

For the purpose of illustration only, FIG. 7B depicts a block diagram of an example service specification 720 in accordance with some embodiments of the present disclosure in comparison with the traditional service specification 650 in FIG. 6.

As mentioned above, the custom resource definition 651 in the traditional service specification 650 comprises a role field to refer to a root role 641, which may indicate a recall function to revoke all the roles 661, 662, 663, . . . , 66N. By contrast, according to embodiments of the present disclosure, a section of custom resource definition 721 in the service specification 720 comprises a roles field to refer to the respective roles 661, 662, 663, . . . , 66N, which allows those roles to be revoked separately.

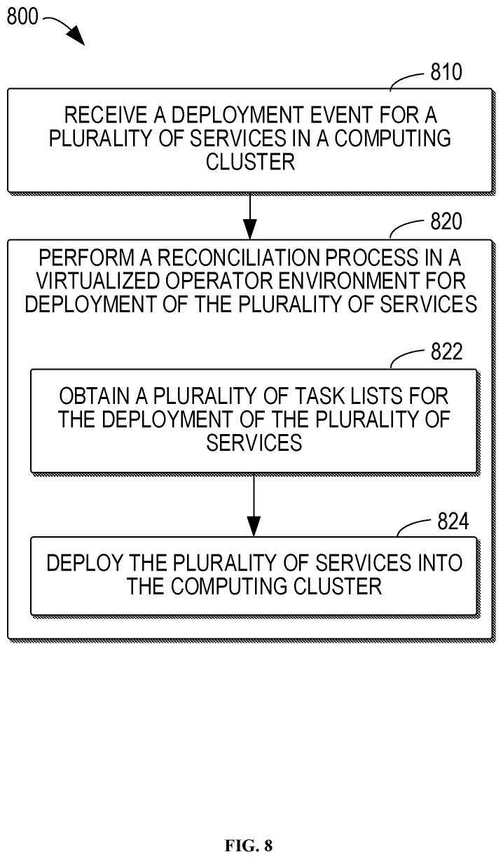

FIG. 8 depicts a flowchart of an example method 800 in accordance with some embodiments of the present disclosure. The method 800 can be implemented at a virtualized operator environment.

At block 810, the virtualized operator environment receives a deployment event for a plurality of services in a computing cluster. The deployment event may be associated with a service specification maintained by the virtualized operator environment for service deployment. The deployment event may comprise a custom resource instance for a custom resource definition in the service specification. In some embodiments, the deployment event may be triggered to deploy new instances of the plurality of services in the computing cluster, or to apply a change to one or more of the plurality of deployed services.

In response to the deployment event, at block 820, the virtualized operator environment performs a reconciliation process for deployment of the plurality of services. The virtualized operator environment may initiate a reconciliation process for a deployment event. The reconciliation process comprises obtaining, at a sub-block 822, a plurality of task lists for the deployment of the plurality of services by parsing a service specification associated with the deployment event, and deploying, at a sub-block 824, the plurality of services into the computing cluster by launching a plurality of executors to at least partially parallelly execute tasks in the plurality of task lists.

In some embodiments, according to the logic configured in the virtualized operator environment for service deployment, corresponding components may be preconfigured and then launched in the virtualized operator environment to perform the reconciliation process. In some embodiments, a reconciler, a master executor, as well as the plurality of executors may be launched in the virtualized operator environment to perform the reconciliation process. In some embodiments, the virtualized operator environment may be an Ansible Operator Container.

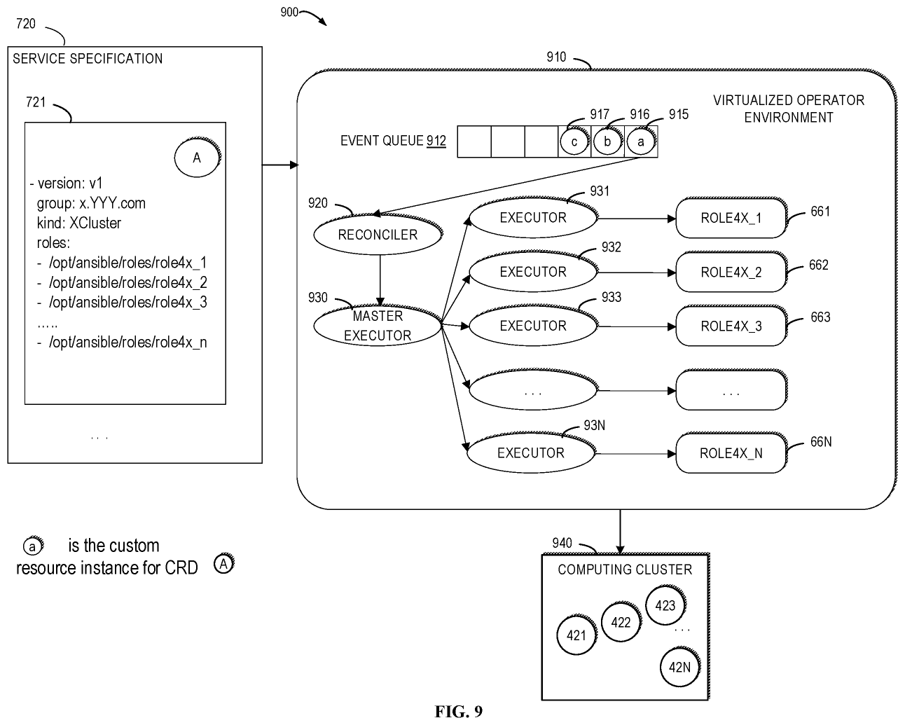

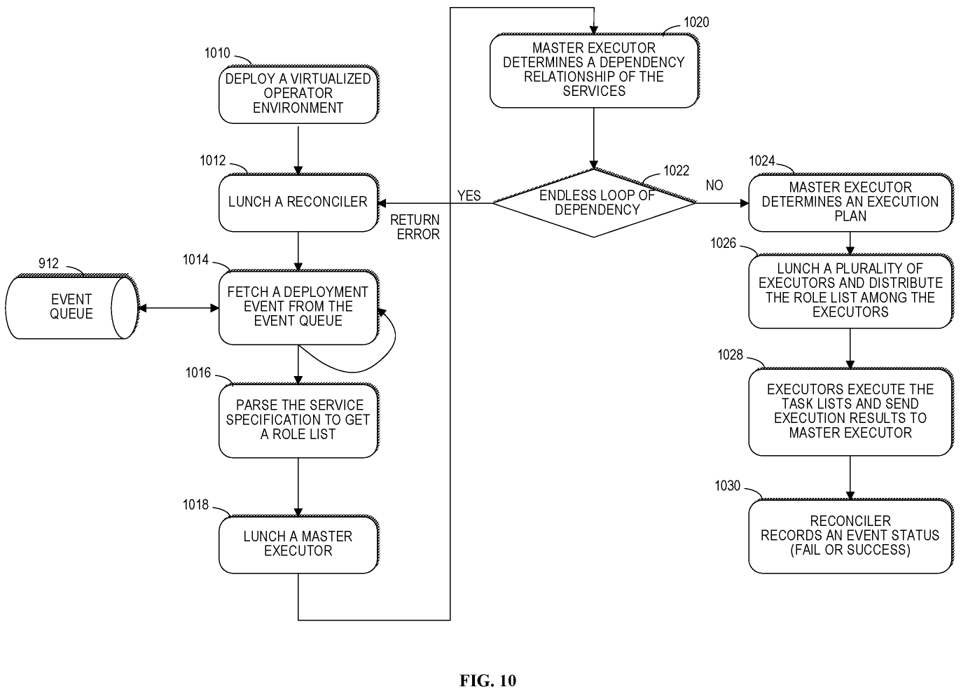

FIG. 9 depicts a block diagram of an example service deployment platform 900 in accordance with some embodiments of the present disclosure. An example virtualized operator environment 910 illustrated in FIG. 9 is based on an Ansible Operator Container. FIG. 10 depicts a flowchart of an example service deployment process 1000 to be implemented in the example service deployment platform 910 in FIG. 9.

As illustrated in FIG. 9, the virtualized operator environment 910 comprises an event queue 912 to store deployment events received by the service deployment platform 910. As an example, deployment events a 915, b 916, c 917 are illustrated to be received and stored in the event queue 912, although it is noted that any other number of deployment events may be stored in the event queue 912.

The virtualized operator environment 910 maintains a service specification 720 which comprises custom resource definitions for a computing cluster 940. For the purpose of discussion, in FIG. 9, the example service specification 720 of FIG. 7B is used as an example. It would be appreciated that the service specification may comprise custom resource definitions for deployment of other services.

In the following, the example service deployment process 1000 will be described with reference to FIG. 9 to discuss some example embodiments of the service deployment in response to a deployment event.

In the example service deployment process 1000, at block 1010, a virtualized operator environment, such as the virtualized operator environment 910 is deployed. The virtualized operator environment 910 may be deployed in a virtual computing environment, such as a cloud, as a container according to an operator image.

At block 1012, the virtualized operator environment 910 launches a reconciler 920. At block 1014, the reconciler 920 fetches a deployment event from the event queue 912 in the virtualized operator environment 910. In response to a deployment event being fetched from the event queue 912, the reconciler 920 initiates a reconciliation process for the deployment event. In some embodiments, if no deployment event is available in the event queue 912, the reconciler 920 may keep fetching periodically or on a trigger-basis.

In the example illustrated in FIG. 9, it is assumed that the reconciler 920 fetches the deployment event a 915 associated with a plurality of services 421, 422, 423, . . . , 42N to be deployed into the computing cluster 940. The reconciler 920 may initiate a reconciliation process in response to the deployment event a 915. Specifically, at block 1016, the reconciler 920 may get a role list by parsing the service specification 720. The reconciler 920 is configured to be able to recognize the new data structure of the service specification 720 and thus can parse the service specification 720 to obtain the role list specified in the roles field. In this example, the role list comprises a plurality of roles, with each role specifying a task list for deployment of one of the services 421, 422, 423, . . . , 42N.

In some embodiments, the deployment event comprises an instance of a custom resource definition 721 in the service specification 720. The instance may also indicate the version, group, and kind of the computing cluster 940. Thus, the reconciler 920 may parse the service specification 720 to identify the section of the custom resource definition 721 from the service specification 720 and identify the plurality of task lists indicated by the service specification 720 for the deployment of the services 421, 422, 423, . . . , 42N.

At block 1018, the reconciler 920 launches a master executor 930 (or a master runner or a runner leader) in the virtualized operator environment 910. The reconciler 920 may distribute tasks in the plurality of task lists parsed from the service specification 720 to the master executor 930.

The master executor 930 is configured to launch a plurality of executors in the virtualized operator environment 910 and distribute the plurality of task lists to the plurality of executors to execute tasks in the plurality of task lists. As illustrated in FIG. 9, the master executor 930 triggers a plurality of executors (or runners) 931, 932, 933, . . . , 93N to be launched in the virtualized operator environment 910. The master executor 930 may distribute the task lists to the executors 931, 932, 933, . . . , 93N for execution tasks in the task lists. Each executor may obtain one of the task lists that is specified by one role in the role list, e.g., one of the roles 661, 662, 663, . . . , 66N to execute tasks therein. In some embodiments, each role may specify a recall path to recall the corresponding task list for deploying the corresponding service in the computing cluster 940.

In some cases, the executors 931, 932, 933, . . . , 93N may operate their task lists separately. In some embodiments, the executors 931, 932, 933, . . . , 93N may operate their task lists specified by the roles 661, 662, 663, . . . , 66N to execute tasks therein at least partially in parallel.

In some embodiments, the (partially or fully) parallel execution of tasks in one or more task lists may depend on a dependency relationship between the plurality of services. For example, if a first service depends on a second service, deployment of the first service may fail if the second service has not been successfully deployed. By considering the dependency relationship, it is possible to improve the success rate of deployment of the services.

In some embodiments of the present disclosure, the master executor 930, which can control the launching of the executors 931, 932, 933, . . . , 93N, may be configured to determine an execution plan for at least partially parallel execution of the plurality of task list based on a dependency relationship between the plurality of services 421, 422, 423, . . . , 42N.

Specifically, still referring to FIG. 10, at block 1020 in the process 1000, the master executor 930 determines a dependency relationship between the plurality of services 421, 422, 423, . . . , 42N. For a certain service, the dependency relationship may indicate whether this service depends on one or more other services, and/or whether one or more other services depend on this service.

At block 1022, the master executor 930 analyzes the dependency relationship and determines whether it is an endless loop of dependency for the services 421, 422, 423, . . . , 42N. An endless loop of dependency indicates that an inaccurate dependency relationship is defined for the services. For example, a first service depends on a second service, a second service depends on a third service, while the third service depends on the first service. In this example, there is an endless loop among the three services because it is impossible to determine a deployment order to successfully deploy the three services.

The endless loop of dependency may occur generally because the dependency relationship between the services is claimed in a wrong way. In the case that the master executor 930 identifies an endless loop of dependency, it may return an error of the reconciliation process to the reconciler 920. The reconciler 920 may suspend the reconciliation process and return an error to the user, to allow the user to check and correct the dependency relationship of the services.

If no endless loop of dependency is found, at block 1024, the master executor 930 determines an execution plan for at least partially parallel execution of tasks in the plurality of task lists based on the dependency relationship. Then at block 1026, the master executor 930 launches the executors 931, 932, 933, . . . , 93N according to the determined execution plan and distributes roles in the role list among the executors to cause the executors to execute tasks in the corresponding task lists specified by the roles in the role list.

The execution plan may indicate an execution order for at least partially parallelly executing tasks in the task lists by the executors 931, 932, 933, . . . , 93N. The execution plan may indicate which tasks in one or more task lists can be executed first, and followed by execution of tasks in one or more other task lists. In some embodiments, if a service depends on another service, the execution plan may be determined to indicate that tasks in a task list for deployment of the service is to be executed after tasks in another task list for deployment of the other service. In some embodiments, if two or more services do not depend on each other, then tasks in the two or more task lists for deployment of these services may be executed in parallel, so as to reduce the deployment time consumption.

The dependency relationship can be utilized to determine a more appropriate execution plan to allow successful service deployment and also increase the deployment efficiency by allowing services without dependency to be deployed in parallel.

In some embodiments, the dependency relationship between the plurality of services may be configured in the service specification 720. According to the traditional sequential service deployment approach, the sequential order of deployment of a plurality of services may need to be determined in advance and written in a service specification, for example, by defining the order of roles in the service specification. This may increase the workload for users who configure the service specification. According to those embodiments of the specification, by simply configuring the dependency relationship between the plurality of services, a more appropriate execution plan can be automatically generated. The execution plane may not only allow successful service deployment but also increase the deployment efficiency by allowing services without dependency to be deployed in parallel.

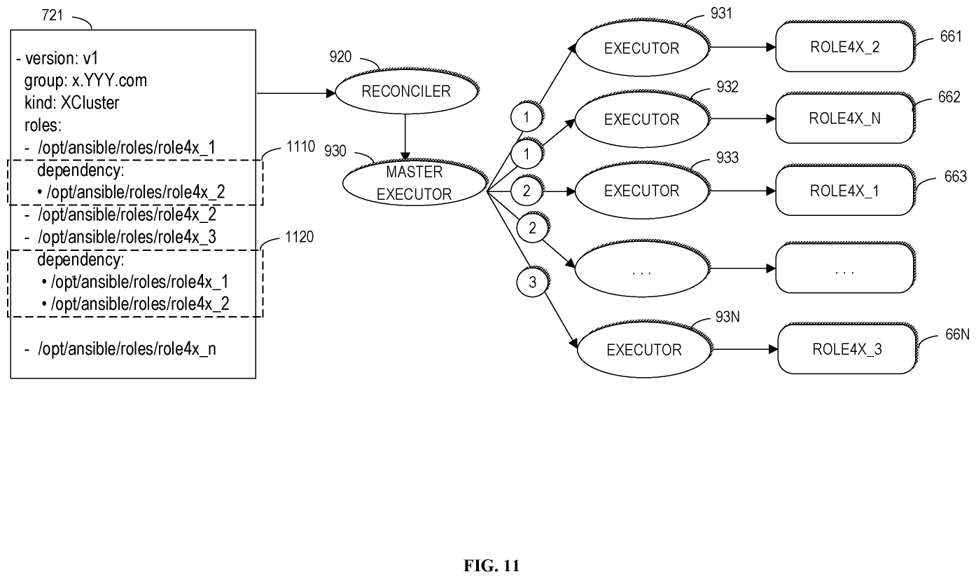

FIG. 11 depicts an example portion of the virtualized operator environment considering the dependency relationship defined in the service specification 720. In the example of FIG. 11, the section of custom resource definition 721 in the service specification 720 may specify which service(s) depend on which other service(s). For example, a dependency field may be added for each role. Since the roles have a one-to-one correspondence with the services, the dependency relationship between the services to be deployed may be specified as a dependency relationship between the roles in the service specification 720.

As illustrated, a dependency field 1110 for Role4X_1 indicates that the service whose task list specified by this role depends on a service whose task list is specified by Role4X_2. A dependency field 1120 for Role4X_3 indicates that the service whose task list is specified by this role depends on the service whose task list is specified by Role4X_1 and a service whose task list is specified by Role4X_2.

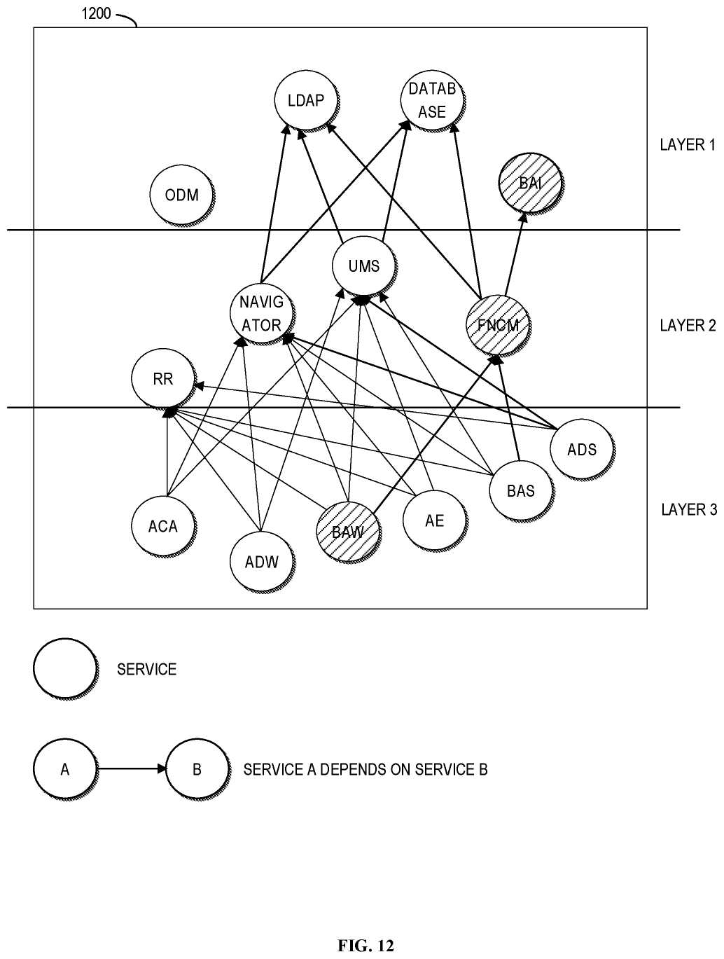

FIG. 12 depicts an example dependency graph 1200 showing a dependency relationship from which an execution plan is determined in accordance with some embodiments of the present disclosure. In the dependency graph 1200, a dependency relationship from one service to another service is represented by an arrow from the service to the other service. The master executor 930 may construct such a dependency graph 1200 after parsing the dependency specified for the roles in the service specification. According to the dependency relationship, the master executor 930 may identify three layers from the dependency graph 1200, i.e., Layer 1, Layer 2, and Layer 3. Each layer comprises several services that do not depend on each other. A service at one layer may depend on one or more services in another layer. For example, services “ODM”, “LDAP”, “DATABASE” and “BAI” at Layer 1 have no dependency with each other, a service “UMS” at Layer 2 depends on the services “LDAP” and “DATABASE” at Layer 1 but does not depend on services at Layer 3.

Depending on the dependency relationship indicated by the dependency group graph 1200, the master executor 930 may determine an execution plan to trigger corresponding executors to first execute tasks in task lists for deployment of the services at Layer 1 in parallel, to further trigger corresponding executors to execute tasks in task lists for deployment of the services at Layer 2 in parallel after the services at Layer 1 have been deployed, and finally to trigger corresponding executors to execute tasks in task lists for deployment of the services at Layer 3 in parallel after the services at Layer 2 have been deployed.

Referring back to FIG. 11, it is illustrated in this figure another example of how the master executor 930 causes the executors 931, 932, 933, . . . , 93N to execute tasks in the task list according to the execution layer. In this example, according to the determined execution plan, the master executor 930 may trigger executors 931 and 932 to be launched in a first batch, to execute tasks in task lists specified by the roles 661 and 662 respectively. The executors 931 and 932 may run in a parallel manner. After tasks in the task lists have been completed by the executors 931 and 932 to deploy the corresponding services, the master executor 930 may trigger executors 933 and one or more other executors (if any) to be launched in a second batch, to execute tasks in corresponding task lists. The master executor 930 may trigger the executors 93N to be launched in a third batch, to execute tasks in the task list specified by the role 66N.

At block 1028 of the process 1000, the executors 931, 932, 933, . . . , 93N execute tasks in the corresponding task lists specified in the service specification. The executors may execute tasks in the task lists under the control of the master executor 930 based on the execution plan, as discussed above. In some embodiments, the executors 931, 932, 933, . . . , 93N may send execution results of tasks in the respective task lists to the master executor 930. An execution result sent from an executor may indicate whether tasks in a task list for deployment of a service have been successfully executed so the service can be successfully deployed. The master executor 930 may send the execution results of tasks in the respective task lists collected from the executors 931, 932, 933, . . . , 93N to the reconciler 920.

At block 1030, the reconciler 920 records an event status for the deployment event based on the plurality of execution results, the event status indicating whether the deployment of the plurality of services succeed or fail. In some embodiments, the reconciler 920 may aggregate the plurality of execution results to indicate an overall event status. For example, if one of the execution results indicates a failed deployment of a service, then the event status may be determined to indicate that the deployment of the plurality of services failed. In some embodiments, the reconciler 920 may record the respective execution results as an event status. The event status may be provided to a user who may acknowledge from the event status whether the deployment succeeded or which service(s) cannot be successfully deployed.

As compared with the event status which can only indicate an overall failure or success status of all the services, the execution of tasks in the task lists by the plurality of executors in accordance with the embodiments of the present disclosure may allow a fine-grained indication of execution results in deploying the respective services.

As discussed above, depending on the dependency relationship, some of the services may be deployed in parallel with each other but may be deployed before or after some other services have been successfully deployed. In embodiments of the present disclosure, by launching a plurality of executors, it is possible to at least partially parallelize the deployment of some services. In cases where the plurality of services are to be deployed in a partially parallel manner in several batches, such as in the example of FIG. 12, for each batch of service deployment performed by one or more executors, the deployment time depends on the service which requires the longest time to execute tasks in the task list for deployment. The total deployment time may be a sum of the longest time consumptions in the batches. Even if in this case, the deployment time can still be reduced as compared with the traditional sequential deployment, especially if the number of services comprised in a software product is relatively large.

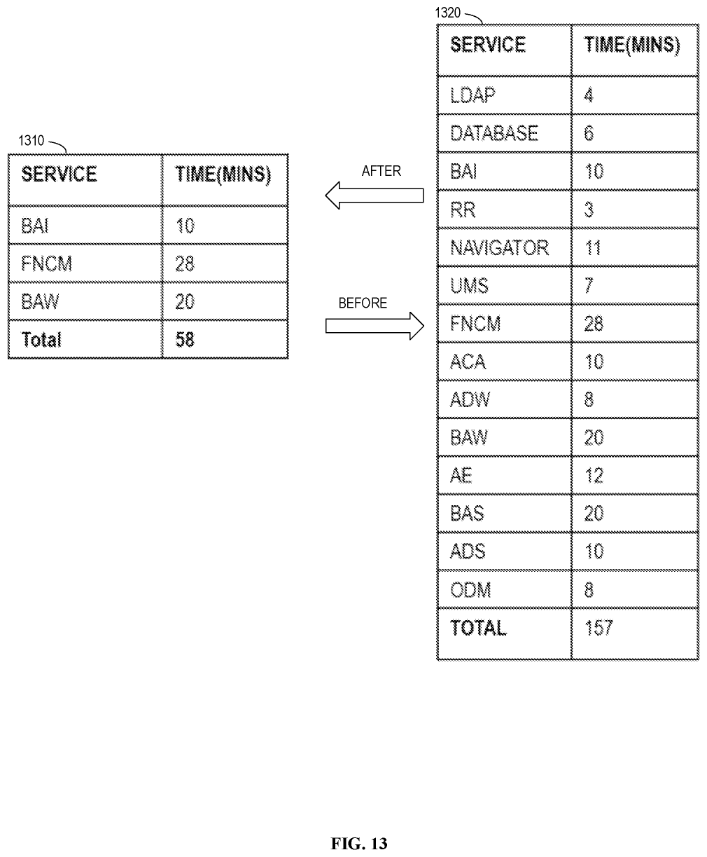

FIG. 13 depicts an example comparison of a total deployment time required using a traditional approach and a total deployment time in the example of FIG. 12 in accordance with some embodiments of the present disclosure. In a table 1310, it is assumed that the service “BAI” requires the longest deployment time (e.g., 10 minutes) among the services at Layer 1, the service “FNCM” requires the longest deployment time (e.g., 28 minutes) among the services at Layer 2, and the service “BAW” requires the longest deployment time (e.g., 20 minutes) among the services at Layer 3. The total deployment time in the example of FIG. 12 is 58 minutes.

A table 1320 lists respective deployment times required by the services involved in the example of FIG. 12. If the traditional sequential service deployment approach is applied, the total deployment time is a sum of the respective deployment times required by the services, e.g., 157 minutes, which is much larger than the total deployment time according to the embodiments of the present disclosure.

It should be noted that the processing of service deployment according to embodiments of this disclosure could be implemented by computer system/server 12 of FIG. 1. In some embodiments, deployment includes activities that make a software system available for use. The general deployment process consists of several interrelated activities with possible transitions between them. These activities can occur at the producer side or at the consumer side or both.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving, by one or more processors, a deployment event for a plurality of services in a computing cluster; and
performing, by the one or more processors, a reconciliation process in a virtualized operator environment for deployment of the plurality of services, the reconciliation process comprising:
obtaining, by the one or more processors, a plurality of task lists for the deployment of the plurality of services by parsing a service specification associated with the deployment event, and
deploying, by the one or more processors, the plurality of services into the computing cluster by launching a plurality of executors to at least partially parallelly execute tasks in the plurality of task lists.

2. The method of claim 1, wherein the deployment event comprises an instance of a custom resource definition for the computing cluster, and wherein parsing the service specification comprises:
parsing the service specification according to the instance of the custom resource definition.

3. The method of claim 1, wherein parsing the service specification comprises:
in response to receiving the deployment event, launching a reconciler in the virtualized operator environment to parse the service specification.

4. The method of claim 3, wherein launching the plurality of executors comprises:
triggering, by the reconciler, a master executor to be launched in the virtualized operator environment;
distributing, by the reconciler, the plurality of task lists to the master executor; and
causing, by the master executor, the plurality of executors to be launched in the virtualized operator environment.

5. The method of claim 1, wherein the service specification indicates a dependency relationship between the plurality of services, and
wherein launching the plurality of executors comprises:
determining, based on the dependency relationship, an execution plan for at least partially parallel execution of the tasks in the plurality of task lists; and
launching the plurality of executors according to the execution plan.

6. The method of claim 5, wherein the dependency relationship indicates that a first service of the plurality of services depends on a second service of the plurality of services, and a third service of the plurality of services does not depend on a fourth service of the plurality of services, and
wherein the execution plan indicates that tasks in a first task list of the plurality of task lists for deployment of the first service are to be executed after tasks in a second task list of the plurality of task lists for deployment of the second service, and tasks in a third task list of the plurality of task lists for deployment of the third service are to be executed in parallel with execution of tasks in a fourth task list of the plurality of task lists for deployment of the fourth service.

7. The method of claim 1, wherein the virtualized operator environment comprises an Ansible operator, and
wherein the service specification comprises a role list with each of the plurality of task lists specified as one role in the role list.

8. The method of claim 1, further comprising:
collecting, by the one or more processors, a plurality of execution results of the tasks in the plurality of task lists from the plurality of executors; and
determining, by the one or more processors, an event status for the deployment event based on the plurality of execution results, the event status indicating whether the deployment of the plurality of services successes or fails.

9. A system comprising:
a processing unit; and
a memory coupled to the processing unit and storing instructions thereon, the instructions, when executed by the processing unit, performing acts including:
receiving a deployment event for a plurality of services in a computing cluster; and
performing a reconciliation process in a virtualized operator environment for deployment of the plurality of services, the reconciliation process comprising:
obtaining a plurality of task lists for the deployment of the plurality of services by parsing a service specification associated with the deployment event, and
deploying the plurality of services into the computing cluster by launching a plurality of executors to at least partially parallelly execute tasks in the plurality of task lists.

10. The system of claim 9, wherein the deployment event comprises an instance of a custom resource definition for the computing cluster, and wherein parsing the service specification comprises:
parsing the service specification according to the instance of the custom resource definition.

11. The system of claim 9, wherein parsing the service specification comprises:
in response to receiving the deployment event, launching a reconciler in the virtualized operator environment to parse the service specification.

12. The system of claim 11, wherein launching the plurality of executors comprises:
triggering, by the reconciler, a master executor to be launched in the virtualized operator environment;
distributing, by the reconciler, the plurality of task lists to the master executor; and
causing, by the master executor, the plurality of executors to be launched in the virtualized operator environment.

13. The system of claim 9, wherein the service specification indicates a dependency relationship between the plurality of services, and
wherein launching the plurality of executors comprises:
determining, based on the dependency relationship, an execution plan for at least partially parallel execution of the tasks in the plurality of task lists; and
launching the plurality of executors according to the execution plan.

14. The system of claim 13, wherein the dependency relationship indicates that a first service of the plurality of services depends on a second service of the plurality of services, and a third service of the plurality of services does not depend on a fourth service of the plurality of services, and
wherein the execution plan indicates that tasks in a first task list of the plurality of task lists for deployment of the first service are to be executed after tasks in a second task list of the plurality of task lists for deployment of the second service, and tasks in a third task list of the plurality of task lists for deployment of the third service are to be executed in parallel with execution of tasks in a fourth task list of the plurality of task lists for deployment of the fourth service.

15. The system of claim 9, wherein the virtualized operator environment comprises an Ansible operator, and
wherein the service specification comprises a role list with each of the plurality of task lists specified as one role in the role list.

16. The system of claim 9, wherein the acts further include:
collecting, by the processing unit, a plurality of execution results of the tasks in the plurality of task lists from the plurality of executors; and
determining, by the processing unit, an event status for the deployment event based on the plurality of execution results, the event status indicating whether the deployment of the plurality of services successes or fails.

17. A computer program product being tangibly stored on a non-transient machine-readable medium and comprising machine-executable instructions, the instructions, when executed on a device, causing the device to perform acts including:
receiving a deployment event for a plurality of services in a computing cluster; and
performing a reconciliation process in a virtualized operator environment for deployment of the plurality of services, the reconciliation process comprising:
obtaining a plurality of task lists for the deployment of the plurality of services by parsing a service specification associated with the deployment event, and
deploying the plurality of services into the computing cluster by launching a plurality of executors to at least partially parallelly execute tasks in the plurality of task lists.

18. The computer program product of claim 17, wherein the deployment event comprises an instance of a custom resource definition for the computing cluster, and wherein parsing the service specification comprises:
parsing the service specification according to the instance of the custom resource definition.

19. The computer program product of claim 17, wherein the service specification indicates a dependency relationship between the plurality of services, and
wherein launching the plurality of executors comprises:
determining, based on the dependency relationship, an execution plan for at least partially parallel execution of the tasks in the plurality of task lists; and
launching the plurality of executors according to the execution plan.

20. The computer program product of claim 19, wherein the dependency relationship indicates that a first service of the plurality of services depends on a second service of the plurality of services, and a third service of the plurality of services does not depend on a fourth service of the plurality of services, and
wherein the execution plan indicates that tasks in a first task list of the plurality of task lists for deployment of the first service are to be executed after tasks in a second task list of the plurality of task lists for deployment of the second service, and tasks in a third task list of the plurality of task lists for deployment of the third service are to be executed in parallel with execution of tasks in a fourth task list of the plurality of task lists for deployment of the fourth service.
